(19) United States
(12) Patent Application Publication
(10) Pub. No.: US 2025/0155598 A1
(43) Pub. Date: May 15, 2025

(54) REPEATABILITY ENFORCEMENT FOR MEASURED DATA

(71) Applicant: Schlumberger Technology Corporation, Sugar Land, TX (US)

(72) Inventors: Wenyi Hu, Fulshear, TX (US); Son Phan, Houston, TX (US); Cen Li, Missouri City, TX (US); Aria Abubakar, Sugar Land, TX (US)

(21) Appl. No.: 18/838,549

(22) PCT Filed: May 10, 2023
(86) PCT No.: PCT/US2023/021706

§ 371 Date: Aug. 14, 2024

Related U.S. Application Data
(60) Provisional application No. 63/364,484, filed on May 10, 2022.

(51) Int. Cl. G01V 1/30; E21B 43/16

(52) U.S. Cl. CPC G01V 1/308; E21B 43/164; E21B 2200/22; G01V 2210/6161

(57) ABSTRACT

A method includes receiving baseline data representing an area corresponding to a first time. receiving first measurement data representing a first portion of the area corresponding to a second time subsequent to the first time. training a machine learning model to reduce an influence of a non-repeatability factor based on a combination of the baseline data and the first measurement data. receiving second measurement data representing a second portion of the area corresponding to the second time. the second portion of the area including a feature of interest that was not present at the first time or that has changed between the first and second times. and modifying the second measurement data using the machine learning model to remove the non-repeatability factor in the second measurement data.

### CROSS-REFERENCE TO RELATED APPLICATIONS

This application claims priority to U.S. Provisional Patent Application Ser. No. 63/364,484, which was filed on May 10, 2022, and is incorporated herein by reference in its entirety.

### BACKGROUND

Seismic data is employed to infer characteristics about the subsurface, and has a variety of uses, including oilfield exploration and production, among others. Recently, there has been an interest in recognizing changes in the subsurface over relatively short, e.g., non-geological time scales, particularly in handling greenhouse gases through subsurface carbon sequestration. For example, carbon dioxide (CO2) may be injected into a subsurface formation through a well, generating a plume body. It may be desirable to analyze the position, shape, stability, and/or other characteristics of the CO2 plume body, which may change on such non-geological time scales. This type of analysis may also be applicable to reservoir production, e.g., the withdrawing of hydrocarbons from a reservoir.

In such applications, “time-lapse” seismic projects may be conducted for reservoir surveillance and CO2 monitoring. Time-lapse seismic data includes a baseline dataset and multiple monitoring datasets. The time-lapse difference between the baseline data and the monitoring data may be calculated to derive the subsurface property changes caused by oil/gas production or CO2 sequestration and its plume body migration, for example.

Direct subtraction of the baseline data from the monitoring data may result in “artifacts”, e.g., areas where desirable data signals have been removed or modified and/or where spurious signals have not been removed. Such artifacts may be caused by “non-repeatability” of time-lapse data, e.g., the influence of factors other than the presence of features of interest in the subsurface. These factors may include seasonal change of near surface conditions, water velocity change depending on the salinity and temperature, different source wavelets used in the baseline data acquisition and the monitoring data acquisition. These factors and others can lead to the measurements being influenced in a manner that is not repeatable, e.g., might be different each time a measurement is taken or otherwise difficult to anticipate.

Some data non-repeatability issues are accounted for in current processing schemes. For example, non-repeatability related to dislocation of sources and receivers can be effectively removed by data interpolation or data regularization procedures. However, many other data non-repeatability problems (e.g., near surface condition changes) are more difficult to solve, because the artifacts are generated according to a variety of factors, including changing surface environment, sensor arrangement and/or sensitivity, and/or other sources of noise, which makes modeling and adaptive subtraction thereof a challenge.

### SUMMARY

Embodiments of the disclosure include a method that includes receiving baseline data representing an area corresponding to a first time, receiving first measurement data representing a first portion of the area corresponding to a second time subsequent to the first time, training a machine learning model to reduce an influence of a non-repeatability factor based on a combination of the baseline data and the first measurement data, receiving second measurement data representing a second portion of the area corresponding to the second time, the second portion of the area including a feature of interest that was not present at the first time or that has changed between the first and second times, and modifying the second measurement data using the machine learning model to remove the non-repeatability factor in the second measurement data.

Embodiments of the disclosure include a computing system that includes one or more processors, and a memory storing instructions that, when executed by at least one of the one or more processors, cause the computing system to perform operations. The operations include receiving baseline data representing an area corresponding to a first time, receiving first measurement data representing a first portion of the area corresponding to a second time subsequent to the first time, training a machine learning model to reduce an influence of a non-repeatability factor based on a combination of the baseline data and the first measurement data, receiving second measurement data representing a second portion of the area corresponding to the second time, the second portion of the area including a feature of interest that was not present at the first time or that has changed between the first and second times, and modifying the second measurement data using the machine learning model to remove the non-repeatability factor in the second measurement data.

Embodiments of the disclosure include a non-transitory, computer readable medium storing instructions that, when executed by at least one processor of a computing system, cause the computing system to perform operations. The operations include receiving baseline data representing an area corresponding to a first time, receiving first measurement data representing a first portion of the area corresponding to a second time subsequent to the first time, training a machine learning model to reduce an influence of a non-repeatability factor based on a combination of the baseline data and the first measurement data, receiving second measurement data representing a second portion of the area corresponding to the second time, the second portion of the area including a feature of interest that was not present at the first time or that has changed between the first and second times, and modifying the second measurement data using the machine learning model to remove the non-repeatability factor in the second measurement data.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIGS. 1A, 1B, 1C, 1D, 2, 3A, and 3B illustrate simplified, schematic views of an oilfield and its operation, according to an embodiment.

FIG. 4 illustrates a flowchart of a method for suppressing non-repeatability in a data set, according to an embodiment.

FIG. 5A illustrates a view of a baseline velocity data image, according to an embodiment.

FIG. 5B illustrates a view of a shallow velocity perturbation image, according to an embodiment.

FIG. 5C illustrates a view of a velocity anomaly, according to an embodiment.

FIG. 5D illustrates a combination image made up of the images, according to an embodiment.

FIG. 6A illustrates a plan view of a survey area and a data acquisition system positioned in the area, according to an embodiment.

FIG. 6B illustrates a plan view of the survey area with another data acquisition system, according to an embodiment.

FIG. 7 illustrates a flowchart of a method for enforcing repeatability in a data acquisition system, according to an embodiment.

FIG. 8 illustrates a diagrammatic view of a workflow for training a machine learning model to enforce repeatability (e.g., attenuate non-repeatability factors), according to an embodiment.

FIG. 9 illustrates a diagrammatic view of a workflow for implementing a machine learning model to enforce repeatability (e.g., attenuate non-repeatability factors), according to an embodiment.

FIG. 10 illustrates a schematic view of a computing system, according to an embodiment.

### DESCRIPTION OF EMBODIMENTS

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object could be termed a second object, and, similarly, a second object could be termed a first object, without departing from the scope of the invention. The first object and the second object are both objects, respectively, but they are not to be considered the same object.

The terminology used in the description of the invention herein is for the purpose of describing particular embodiments only and is not intended to be limiting of the invention. As used in the description of the invention and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques and workflows that are in accordance with some embodiments. Some operations in the processing procedures, methods, techniques and workflows disclosed herein may be combined and/or the order of some operations may be changed. Although embodiments of the present disclosure are discussed in terms of seismic data acquisition, it will be appreciated that any sort of measurement and/or visual data may be processed using one or more of the embodiments discussed herein.

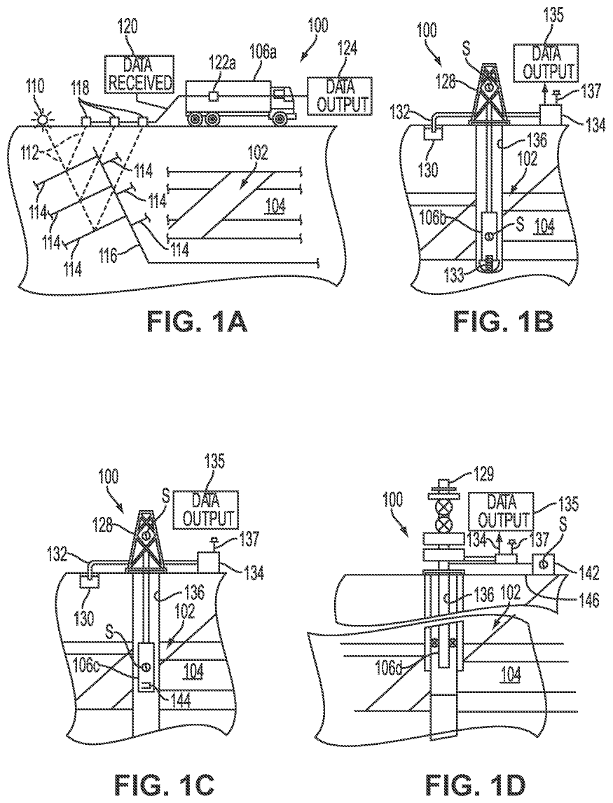

FIGS. 1A-1D illustrate simplified, schematic views of oilfield 100 having subterranean formation 102 containing reservoir 104 therein in accordance with implementations of various technologies and techniques described herein. FIG. 1A illustrates a survey operation being performed by a survey tool, such as seismic truck 106a, to measure properties of the subterranean formation. The survey operation is a seismic survey operation for producing sound vibrations. In FIG. 1A, one such sound vibration, e.g., sound vibration 112 generated by source 110, reflects off horizons 114 in earth formation 116. A set of sound vibrations is received by sensors, such as geophone-receivers 118, situated on the earth's surface. The data received 120 is provided as input data to a computer 122a of a seismic truck 106a, and responsive to the input data, computer 122a generates seismic data output 124. This seismic data output may be stored, transmitted or further processed as desired, for example, by data reduction.

FIG. 1B illustrates a drilling operation being performed by drilling tools 106b suspended by rig 128 and advanced into subterranean formations 102 to form wellbore 136. Mud pit 130 is used to draw drilling mud into the drilling tools via flow line 132 for circulating drilling mud down through the drilling tools, then up wellbore 136 and back to the surface. The drilling mud is typically filtered and returned to the mud pit. A circulating system may be used for storing, controlling, or filtering the flowing drilling mud. The drilling tools are advanced into subterranean formations 102 to reach reservoir 104. Each well may target one or more reservoirs. The drilling tools are adapted for measuring downhole properties using logging while drilling tools. The logging while drilling tools may also be adapted for taking core sample 133 as shown.

Computer facilities may be positioned at various locations about the oilfield 100 (e.g., the surface unit 134) and/or at remote locations. Surface unit 134 may be used to communicate with the drilling tools and/or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produce data output 135, which may then be stored or transmitted.

Sensors(S), such as gauges, may be positioned about oilfield 100 to collect data relating to various oilfield operations as described previously. As shown, sensor(S) is positioned in one or more locations in the drilling tools and/or at rig 128 to measure drilling parameters, such as weight on bit, torque on bit, pressures, temperatures, flow rates, compositions, rotary speed, and/or other parameters of the field operation. Sensors(S) may also be positioned in one or more locations in the circulating system.

Drilling tools 106b may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 134. The bottom hole assembly further includes drill collars for performing various other measurement functions.

The bottom hole assembly may include a communication subassembly that communicates with surface unit 134. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

Typically, the wellbore is drilled according to a drilling plan that is established prior to drilling. The drilling plan typically sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected

The data gathered by sensors(S) may be collected by surface unit 134 and/or other data collection sources for analysis or other processing. The data collected by sensors(S) may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions and/or actuate the controller. In this manner, oilfield 100 may be selectively adjusted based on the data collected. This technique may be used to optimize (or improve) portions of the field operation, such as controlling drilling, weight on bit, pump rates, or other parameters. These adjustments may be made automatically based on computer protocol, and/or manually by an operator. In some cases, well plans may be adjusted to select optimum (or improved) operating conditions, or to avoid problems.

FIG. 1C illustrates a wireline operation being performed by wireline tool 106c suspended by rig 128 and into wellbore 136 of FIG. 1B. Wireline tool 106c is adapted for deployment into wellbore 136 for generating well logs, performing downhole tests and/or collecting samples. Wireline tool 106c may be used to provide another method and apparatus for performing a seismic survey operation. Wireline tool 106c may, for example, have an explosive, radioactive, electrical, or acoustic energy source 144 that sends and/or receives electrical signals to surrounding subterranean formations 102 and fluids therein.

Wireline tool 106c may be operatively connected to, for example, geophones 118 and a computer 122a of a seismic truck 106a of FIG. 1A. Wireline tool 106c may also provide data to surface unit 134. Surface unit 134 may collect data generated during the wireline operation and may produce data output 135 that may be stored or transmitted. Wireline tool 106c may be positioned at various depths in the wellbore 136 to provide a survey or other information relating to the subterranean formation 102.

Sensors(S), such as gauges, may be positioned about oilfield 100 to collect data relating to various field operations as described previously. As shown, sensor S is positioned in wireline tool 106c to measure downhole parameters which relate to, for example porosity, permeability, fluid composition and/or other parameters of the field operation.

FIG. 1D illustrates a production operation being performed by production tool 106d deployed from a production unit or Christmas tree 129 and into completed wellbore 136 for drawing fluid from the downhole reservoirs into surface facilities 142. The fluid flows from reservoir 104 through perforations in the casing (not shown) and into production tool 106d in wellbore 136 and to surface facilities 142 via gathering network 146.

Sensors(S), such as gauges, may be positioned about oilfield 100 to collect data relating to various field operations as described previously. As shown, the sensor(S) may be positioned in production tool 106d or associated equipment, such as Christmas tree 129, gathering network 146, surface facility 142, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

While FIGS. 1B-1D illustrate tools used to measure properties of an oilfield, it will be appreciated that the tools may be used in connection with non-oilfield operations, such as gas fields, mines, aquifers, storage or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors(S) may be located at various positions along the wellbore and/or the monitoring tools to collect and/or monitor the desired data. Other sources of data may also be provided from offsite locations.

The field configurations of FIGS. 1A-1D are intended to provide a brief description of an example of a field usable with oilfield application frameworks. Part of, or the entirety, of oilfield 100 may be on land, water and/or sea. Also, while a single field measured at a single location is depicted, oilfield applications may be utilized with any combination of one or more oilfields, one or more processing facilities and one or more wellsites.

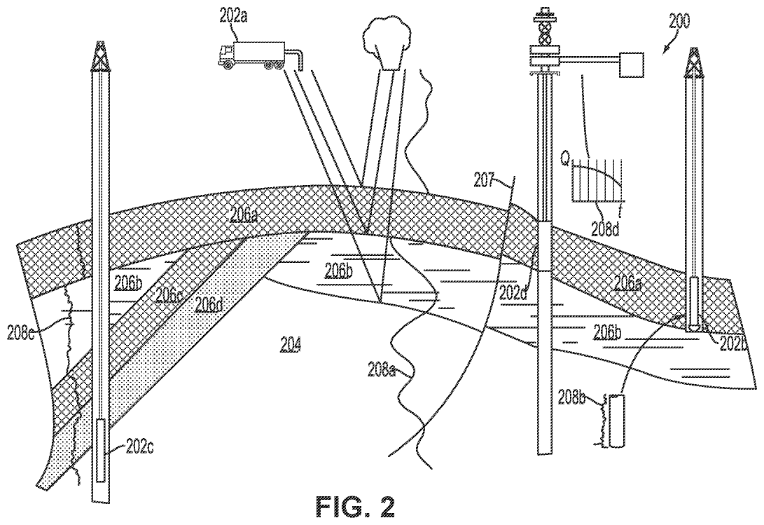

FIG. 2 illustrates a schematic view, partially in cross section of oilfield 200 having data acquisition tools 202a, 202b, 202c and 202d positioned at various locations along oilfield 200 for collecting data of subterranean formation 204 in accordance with implementations of various technologies and techniques described herein. Data acquisition tools 202a-202d may be the same as data acquisition tools 106a-106d of FIGS. 1A-1D, respectively, or others not depicted. As shown, data acquisition tools 202a-202d generate data plots or measurements 208a-208d, respectively. These data plots are depicted along oilfield 200 to demonstrate the data generated by the various operations.

Data plots 208a-208c are examples of static data plots that may be generated by data acquisition tools 202a-202c, respectively; however, it should be understood that data plots 208a-208c may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208a is a seismic two-way response over a period of time. Static plot 208b is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208c is a logging trace that typically provides a resistivity or other measurement of the formation at various depths.

A production decline curve or graph 208d is a dynamic data plot of the fluid flow rate over time. The production decline curve typically provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 204 has a plurality of geological formations 206a-206d. As shown, this structure has several formations or layers, including a shale layer 206a, a carbonate layer 206b, a shale layer 206c and a sand layer 206d. A fault 207 extends through the shale layer 206a and the carbonate layer 206b. The static data acquisition tools are adapted to take measurements and detect characteristics of the formations.

While a specific subterranean formation with specific geological structures is depicted, it will be appreciated that oilfield 200 may contain a variety of geological structures and/or formations, sometimes having extreme complexity. In some locations, typically below the water line, fluid may occupy pore spaces of the formations. Each of the measurement devices may be used to measure properties of the formations and/or its geological features. While each acquisition tool is shown as being in specific locations in oilfield 200, it will be appreciated that one or more types of measurement may be taken at one or more locations across one or more fields or other locations for comparison and/or analysis.

The data collected from various sources, such as the data acquisition tools of FIG. 2, may then be processed and/or evaluated. Typically, seismic data displayed in static data plot 208a from data acquisition tool 202a is used by a geophysicist to determine characteristics of the subterranean formations and features. The core data shown in static plot 208b and/or log data from well log 208c are typically used by a geologist to determine various characteristics of the subterranean formation. The production data from graph 208d is typically used by the reservoir engineer to determine fluid flow reservoir characteristics. The data analyzed by the geologist, geophysicist and the reservoir engineer may be analyzed using modeling techniques.

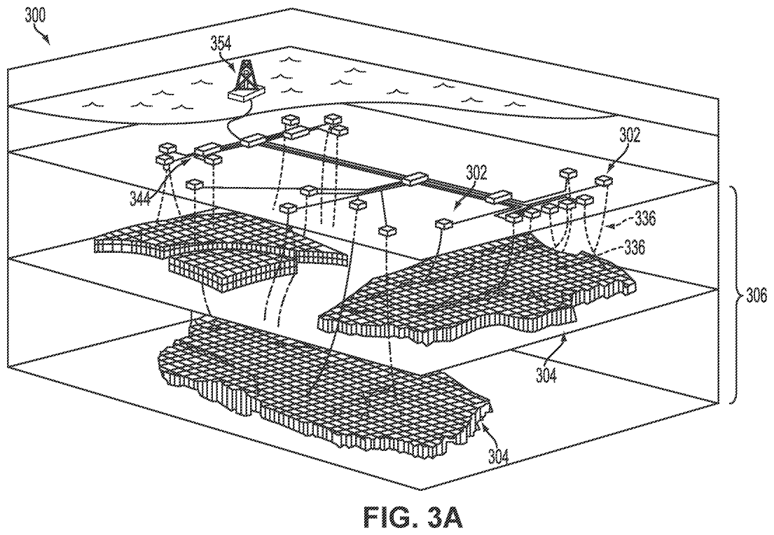

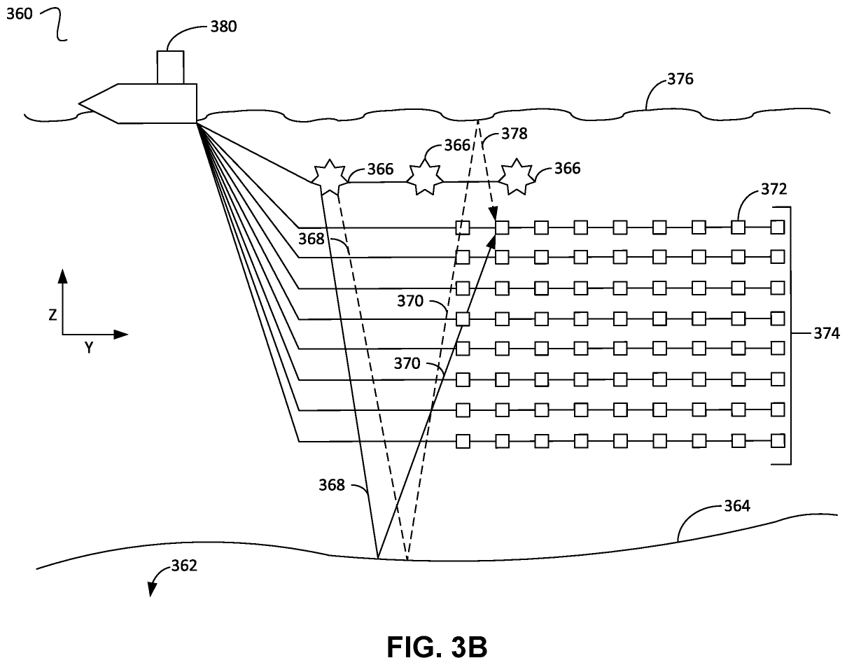

FIG. 3A illustrates an oilfield 300 for performing production operations in accordance with implementations of various technologies and techniques described herein. As shown, the oilfield has a plurality of wellsites 302 operatively connected to central processing facility 354.

The oilfield configuration of FIG. 3A is not intended to limit the scope of the oilfield application system. Part, or all, of the oilfield may be on land and/or sea. Also, while a single oilfield with a single processing facility and a plurality of wellsites is depicted, any combination of one or more oilfields, one or more processing facilities and one or more wellsites may be present.

Each wellsite 302 has equipment that forms wellbore 336 into the Earth. The wellbores extend through subterranean formations 306 including reservoirs 304. These reservoirs 304 contain fluids, such as hydrocarbons. The wellsites draw fluid from the reservoirs and pass them to the processing facilities via surface networks 344. The surface networks 344 have tubing and control mechanisms for controlling the flow of fluids from the wellsite to processing facility 354.

Attention is now directed to FIG. 3B, which illustrates a side view of a marine-based survey 360 of a subterranean subsurface 362 in accordance with one or more implementations of various techniques described herein. Subsurface 362 includes seafloor surface 364. Seismic sources 366 may include marine sources such as vibroseis or airguns, which may propagate seismic waves 368 (e.g., energy signals) into the Earth over an extended period of time or at a nearly instantaneous energy provided by impulsive sources. The seismic waves may be propagated by marine sources as a frequency sweep signal. For example, marine sources of the vibroseis type may initially emit a seismic wave at a low frequency (e.g., 5 Hz) and increase the seismic wave to a high frequency (e.g., 80-90 Hz) over time.

The component(s) of the seismic waves 368 may be reflected and converted by seafloor surface 364 (i.e., reflector), and seismic wave reflections 370 may be received by a plurality of seismic receivers 372. Seismic receivers 372 may be disposed on a plurality of streamers (i.e., streamer array 374). The seismic receivers 372 may generate electrical signals representative of the received seismic wave reflections 370. The electrical signals may be embedded with information regarding the subsurface 362 and captured as a record of seismic data.

In one implementation, each streamer may include streamer steering devices such as a bird, a deflector, a tail buoy and the like, which are not illustrated in this application. The streamer steering devices may be used to control the position of the streamers in accordance with the techniques described herein.

In one implementation, seismic wave reflections 370 may travel upward and reach the water/air interface at the water surface 376, a portion of reflections 370 may then reflect downward again (i.e., sea-surface ghost waves 378) and be received by the plurality of seismic receivers 372.

The sea-surface ghost waves 378 may be referred to as surface multiples. The point on the water surface 376 at which the wave is reflected downward is generally referred to as the downward reflection point.

The electrical signals may be transmitted to a vessel 380 via transmission cables, wireless communication or the like. The vessel 380 may then transmit the electrical signals to a data processing center. Alternatively, the vessel 380 may include an onboard computer capable of processing the electrical signals (i.e., seismic data). Those skilled in the art having the benefit of this disclosure will appreciate that this illustration is highly idealized. For instance, surveys may be of formations deep beneath the surface. The formations may typically include multiple reflectors, some of which may include dipping events, and may generate multiple reflections (including wave conversion) for receipt by the seismic receivers 372. In one implementation, the seismic data may be processed to generate a seismic image of the subsurface 362.

Marine seismic acquisition systems tow each streamer in streamer array 374 at the same depth (e.g., 5-10 m). However, marine based survey 360 may tow each streamer in streamer array 374 at different depths such that seismic data may be acquired and processed in a manner that avoids the effects of destructive interference due to sea-surface ghost waves. For instance, marine-based survey 360 of FIG. 3B illustrates eight streamers towed by vessel 380 at eight different depths. The depth of each streamer may be controlled and maintained using the birds disposed on each streamer.

Embodiments of the present disclosure may include a method of suppressing the non-repeatability (in other words, enforcing repeatability) in time-lapse seismic data, e.g., using deep learning, such as a neural network or another type of machine learning model. In general, the method may first establish the nonlinear mapping between the baseline data and the monitoring data outside of an area of interest (AOI), which may include a feature of interest, such as an oil/gas reservoir area or a CO2 injection area. The method may then apply a trained network to the monitoring data, at least partially eliminating the difference between the monitoring data and the baseline data caused by factors other than changes in the area (e.g., production from reservoir or injection of CO2). In other words, after applying the data repeatability enforcement with this trained machine learning model, the difference between the baseline data and the monitoring data that does not represent the feature of interest may be reduced, e.g., minimized, while the time-lapse data difference representing the feature of interest may be generated based on the change in the feature of interest (e.g., production of oil from the reservoir, CO2 plume body change, etc.). It will be appreciated that embodiments of the present disclosure may be applied to raw pre-stack seismic data, processed pre-stack seismic data, post-stack seismic data, or seismic images, which may all be considered varieties of “seismic data”, broadly.

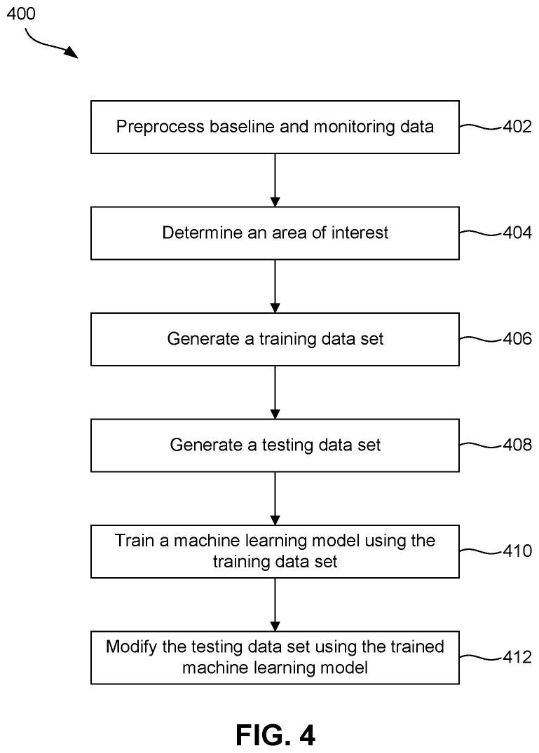

FIG. 4 illustrates a flowchart of a method 400 for suppressing non-repeatability in a data set, according to an embodiment. The various aspects of the method 400 may be executed in the order presented, or in any other order, and/or may be combined, separated, performed in series, in parallel, simultaneously, etc., without departing from the scope of the present disclosure.

The method 400 may include preprocessing baseline and monitoring data, as at 402. The baseline data may be data collected at a “first” time. The first time may be prior to changes or potentially even the existence of the feature of interest in the subsurface area of interest, e.g., before production from a reservoir or before injection of CO2 to create a plume. The monitoring data may be collected at a later, “second” time. The second time may be when the feature of interest is apparent or has changed. The data may be seismic data, and thus seismic surveys may be employed to collect the data. Interpolation or data regularization may be implemented as part of the preprocessing to enable the source/receiver geometry of the baseline data and the monitoring data comparable, so as to permit direct comparison of the baseline data and measurement data. Accordingly, the baseline data and the monitoring data may represent the same area, but at different times. Thus, but for geological changes (e.g., presence of and/or changes in features of interest), the baseline and monitoring data sets would ideally be the same, but because of a variety of factors that contribute to the non-repeatability of the measurements, the two sets of data may differ.

The method 400 may then include determining an area of interest (AOI), as at 404. For example, the AOI may be determined based on a priori information or migration images, such that the seismic data acquired outside of the AOI are not affected by the reservoir property change or the CO2 plume body change. The AOI may be or include the location of one or more features of interest, such as a CO2 plume body, reservoir, etc.

The method 400 may also include generating a training data set, as at 406, and a testing data set, as at 408. The baseline data and the corresponding monitoring data acquired outside of the AOI may be used as the training and testing data sets. The extracted portion of the monitoring data may be the input into the deep learning network for the data repeatability enforcement. The corresponding baseline data may be used as the ground truth.

A machine learning model may then be trained using the training data set, as at 410. The extracted baseline and monitoring data may be input into the machine learning model (e.g., deep learning neural network) as training pairs. Thus, the machine learning model may be trained to force the monitoring data to more closely resemble the baseline data, e.g., by modifying the monitoring data. The difference between the output and the ground truth (the extracted baseline data), that is, the “residual”, may be back-propagated to the machine learning model to update the network parameters. This procedure may be repeated until the network is trained (i.e., the residual is reduced to a certain level or the residual value does not decrease anymore).

The trained machine learning model may then be implemented to modify testing data, e.g., to enforce repeatability and remove effects of factors that are not related to features of interest, as at 412. The difference between the input monitoring dataset (training data) and the baseline dataset may be caused by many mechanisms is removed except for the time-lapse data difference contributed from the reservoir property change, sequestered CO2, or CO2 plume body migration within the AOI.

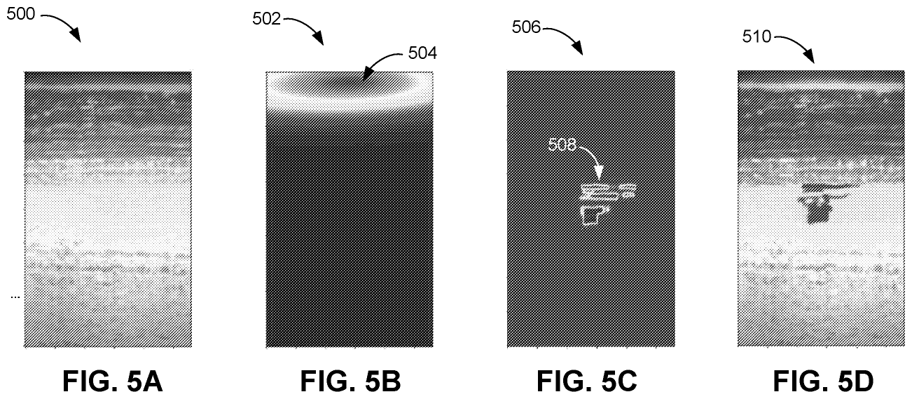

FIG. 5A illustrates a view of a baseline velocity data image 500, according to an embodiment. This image 500 may represent an area of interest prior to introduction of a feature of interest.

FIG. 5B illustrates a view of a shallow velocity perturbation image 502, according to an embodiment. This image 502 illustrates non-linearities, noise, and other aspects that may contribute to the non-repeatability of the data acquisition. In particular, the shallow velocity (near the surface) includes perturbations 504 that may be a function of ambient conditions, time of year, etc.

FIG. 5C illustrates a view of a velocity anomaly image 506. In this image 506, certain anomalies 508 may be caused by the presence of CO2 (e.g., a plume body) or another feature of interest, but may not be directly representative of a physical feature of the subsurface. These anomalies 508 are generated through interpretation of the seismic signals, e.g., based on changes in the velocity of the seismic signal. Such changes represent that the seismic signal has propagated through a medium that differs from the surrounding rock, i.e., the feature of interest or anomaly 508.

FIG. 5D illustrates a combination image 510 made up of the images 500, 502, 506 added (e.g., via superposition) together. As can be seen from the image 510, information about the feature of interest (e.g., the velocity anomaly 508 of FIG. 5C) can be obscured by the perturbations 504 of FIG. 5B.

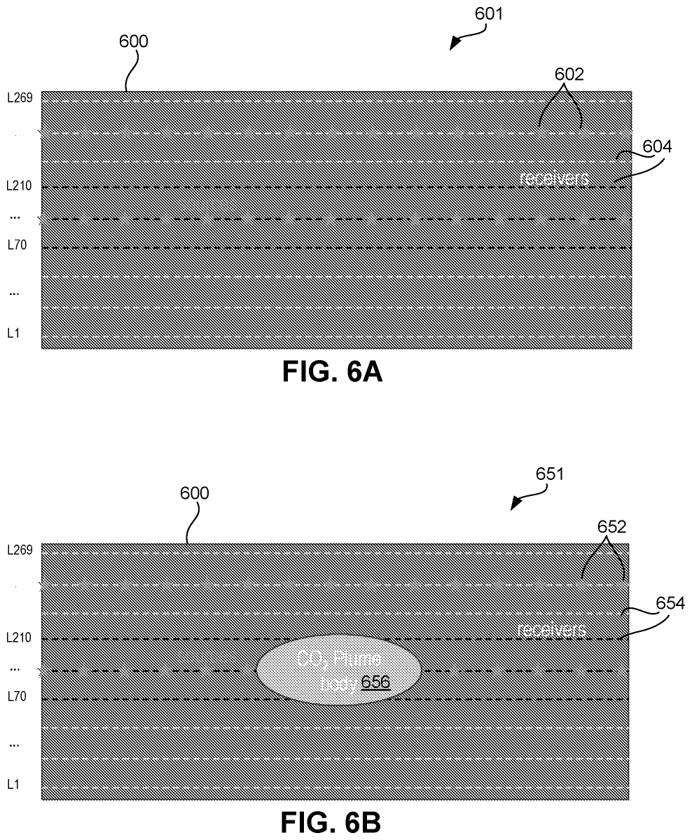

FIG. 6A illustrates a plan view of a survey area 600 and a data acquisition system 601 positioned in the area 600, according to an embodiment. As shown, the system 601 generally includes sources 602 and receivers 604. There may be more receivers 604 than sources 602. Further, the sources 602 may be positioned such that seismic waves propagate through different areas on their way to the respective receivers 604. The sources 602 may be, for example, explosive, percussive, microseismic, or any other suitable source of seismic waves. The receivers 604 may be geophones, hydrophones (e.g., towed in streamers behind a vessel), subsea, on bottom, or any other suitable device for recording seismic waves.

In an example, the system 601 may be illustrative of collecting baseline data. That is, there is no feature of interest at the time represented in FIG. 6A, in this embodiment. As such, the seismic data that is acquired may be representative of the geology of the area, prior to alteration thereof by introduction (or modification) of the feature of interest.

FIG. 6B illustrates the survey area 600 at another time, with another data acquisition system 651, according to an embodiment. Like the system 601 of FIG. 6A, the system 651 may include sources 652 and receivers 654. Further, the area 600 may include a feature of interest 656, which may include a reservoir, CO2 (e.g., a plume body), or any other physical aspect of the area 600. The feature of interest 656 may thus change in a non-geological time-scale, e.g., between the time at which the baseline data is acquired using the system 601 of FIG. 6, and when the monitoring data is collected using the system 651. A non-geological time-scale may be on the orders of days, months, or years, in comparison to geological time scales which can be on the order of thousands or millions of years.

The system 651 may be designed such that some of the seismic waves from the sources 652 propagate through the feature of interest 656 before reaching at least one of the receivers 654, and some of the seismic waves from the sources 652 do not propagate through the feature of interest 656 before reaching the receivers 654. Accordingly, two sets of seismic records may be provided by the system 651: one set that propagates through the feature of interest 656 and may thus be expected to differ from the seismic records recorded by the system 601 of FIG. 6A, and one set of records of seismic waves that do not propagate through the feature of interest 656 and may be expected to be the same as the seismic records recorded by the system 601 of FIG. 6A, but for any perturbations, noise, or other non-repeatability factors.

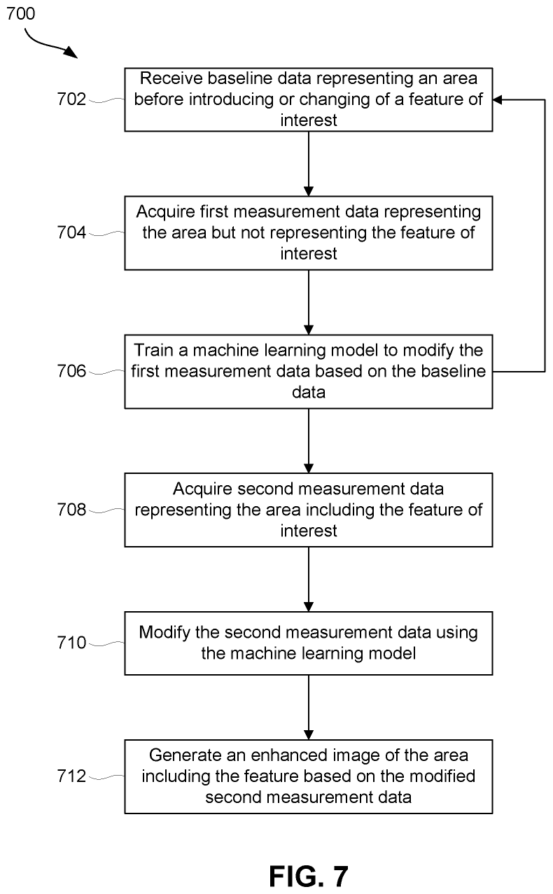

FIG. 7 illustrates a flowchart of a method 700 for enforcing repeatability (or, equivalently, mitigating/reducing non-repeatability) in a data acquisition system, according to an embodiment. The various aspects of the method 700 may be executed in the order presented, or in any other order, and/or may be combined, separated, performed in series, in parallel, simultaneously, etc., without departing from the scope of the present disclosure.

The method 700 may begin by receiving baseline data representing an area at a first time, before introducing or changing of a feature of interest, as at 702. As mentioned above, the feature of interest might be CO2 (e.g., a plume body) or a reservoir from which hydrocarbon is produced, among other possibilities. Thus, at this point, the CO2 may not yet have been injected (e.g., no CO2 plume body) or the reservoir may not have been produced (e.g., hydrocarbons extracted therefrom). It may also be the case that the reservoir has been partially produced, but another alteration (e.g., treatment such as fracturing) has not yet occurred, or simply that the reservoir is going to be produced more than it already has.

The method 700 may then include acquiring first measurement data representing the area, but not representing the feature of interest, as at 704. The first measurement data may be a subset of the monitoring data mentioned above with reference to FIG. 4. For example, an area can be surveyed using a system at a first time, prior to an introduction or modification of a feature of interest, as illustrated in FIG. 6A. As discussed above, at least some of the data collected may not represent the feature of interest, as it may be made up of recordings of seismic waves that did not propagate therethrough, e.g., propagated away from, near, adjacent to, but not through or reflected from the feature of interest.

The method 700 may then include training a machine learning model to modify the first measurement data based on the baseline data, as at 706. As also noted above, if the first measurement data did not propagate through the feature of interest, in geological time, the area 600 of FIG. 6A may be unchanged. Thus, differences between the first measurement data away from the feature of interest and the corresponding baseline data may be attributed to non-repeatability factors. The machine learning model may thus be trained, e.g., using pairings of baseline data and first measurement data to alter the first measurement data to bring it closer into alignment with the baseline data. This training loop may repeat potentially many times until the machine learning model is configured to adjust the first measurement data (e.g., a testing subset thereof) to match the baseline data within a certain threshold error.

The method 700 may then include acquiring second measurement data representing the area and including the feature of interest, as at 708. As explained above with reference to, and illustrated in, FIG. 6B, the second measurement data may include data representing the feature of interest, but also non-repeatability factors, which may be consistent with the non-repeatability factors contained in the first measurement data that does not represent the feature of interest. The second measurement data may be collected at the second time, along with the first measurement data, or at another time. The second measurement data may be a subset of the monitoring data mentioned above with reference to FIG. 4.

The method 700 may then include modifying the second measurement data using the machine learning model that was trained in 708, as at 710. For example, the method 700 may be configured to change the amplitude, strength, polarity, etc., of the (e.g., seismic data) that is acquired, so as to remove or at least mitigate the influence of the non-repeatability factors from the second measurement data.

The method 700 may then include generating an enhanced image of the area including the feature of interest based on the modified second measurement data, as at 712. This generation of the enhanced image may, itself, be a practical application, capitalizing on the functionality of a computer to produce a digital image that accurately represents the subsurface (or any other area of interest). For example, displaying the digital image (e.g., using a computer display) may provide additional detail to a human operator about the existence, location, etc., of the feature of interest, which might have otherwise been too obscured to accurately recognize.

Further, the image may be used to determine characteristics of, performance of, and modifications to on-going or planned operations. For example, the change in shape, location, etc., of a CO2 plume may result in a user changing one or more parameters of the physical system being used to inject CO2. Similarly, change in the location, quality, content, etc., of the reservoir may impact production parameters and/or well plans for future wells in the reservoir. Various other practical applications for the enhanced images, which may provide better accuracy than legacy imaging techniques that retain the non-repeatability factors, may be apparent.

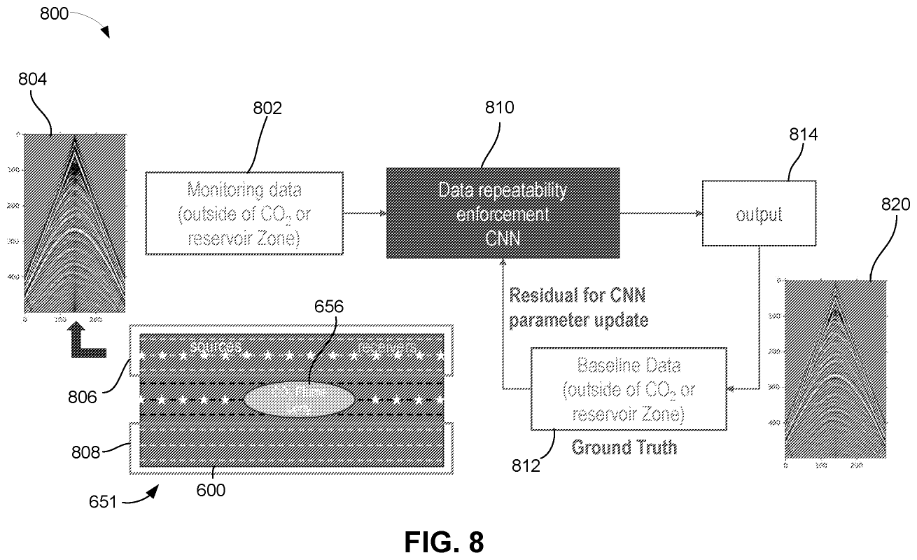

FIG. 8 illustrates a diagrammatic view of a workflow 800 for training a machine learning model to enforce repeatability (e.g., attenuate non-repeatability factors), according to an embodiment. The workflow 800 may be a depiction of the operation of the method 700 of FIG. 7, according to at least one embodiment, e.g., after the baseline data has already been acquired. The workflow 800 may begin by receiving the first measurement data 802, represented as a seismic image 804, from the system 651. Boxes 806, 808 represent the regions of the area 600 represented by the first measurement data 802, which, as can be seen, may not represent the feature of interest 656.

The workflow 800 may then feed this first measurement data 802 to a data repeatability enforcement machine learning model (e.g., convolutional neural network or CNN) 810. The CNN 810 may also be fed the baseline data 812 that was previously collected, such that the baseline data and the first measurement data 802 provide training pairs that represent the same regions within the area 600 (but outside of the feature of interest 656). Output 814 of the CNN 810 may be the modified version of the first measurement data 802, depicted as a seismic image 820, with the non-repeatability factors attenuated. Thus, the output 814 may be compared to the baseline data 812, and the residual differences therebetween used to further train the CNN 810.

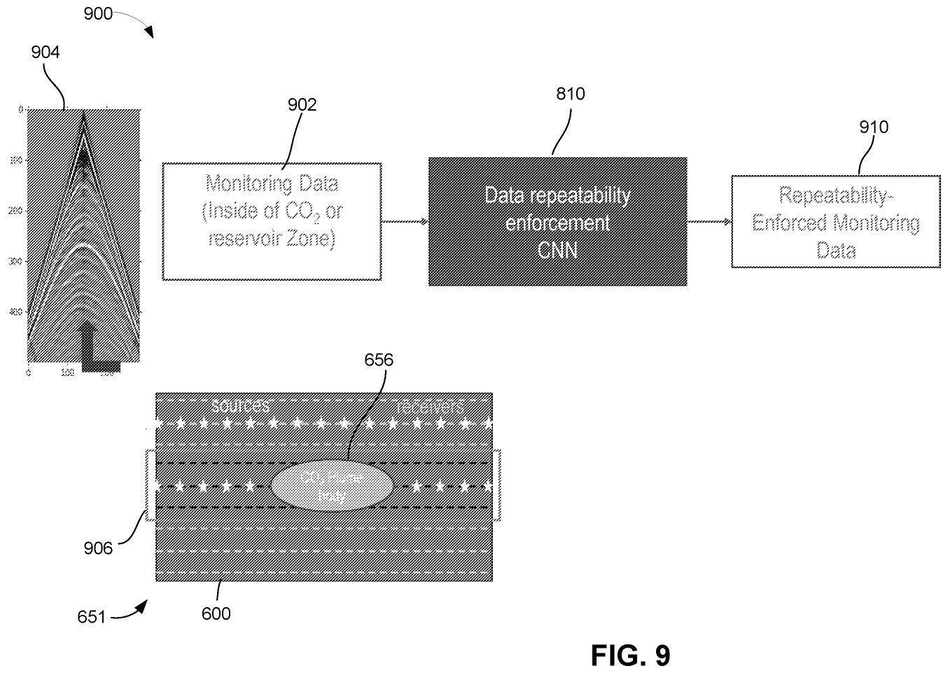

FIG. 9 illustrates a diagrammatic view of a workflow 900 for implementing a machine learning model to enforce repeatability (e.g., attenuate non-repeatability factors), according to an embodiment. In this workflow 900, second measurement data 902 (e.g., a seismic image 904) is collected from the area 600 using the system 651. In particular, the second measurement data 902 represents the box 906, which may be or include the area of interest, and thus at least some of the second measurement data 902 represents the feature of interest 656, which was not present when the baseline data was collected and is not represented by the first measurement data 802 of FIG. 8.

The second measurement data 902 is then fed to the machine learning model (e.g., the CNN 810) that was trained according to the workflow 800 of FIG. 8. The CNN 810 thus modifies the second measurement data 902 to attenuate the non-repeatability factors, according to the training of the CNN 810, resulting in repeatability-enforced monitoring data 910, e.g., a modified version of the second measurement data 902 that may represent the feature of interest 656 more clearly, without (or with less) influence by non-repeatable measurement factors.

In one or more embodiments, the functions described can be implemented in hardware, software, firmware, or any combination thereof. For a software implementation, the techniques described herein can be implemented with modules (e.g., procedures, functions, subprograms, programs, routines, subroutines, modules, software packages, classes, and so on) that perform the functions described herein. A module can be coupled to another module or a hardware circuit by passing and/or receiving information, data, arguments, parameters, or memory contents. Information, arguments, parameters, data, or the like can be passed, forwarded, or transmitted using any suitable means including memory sharing, message passing, token passing, network transmission, and the like. The software codes can be stored in memory units and executed by processors. The memory unit can be implemented within the processor or external to the processor, in which case it can be communicatively coupled to the processor via various means as is known in the art.

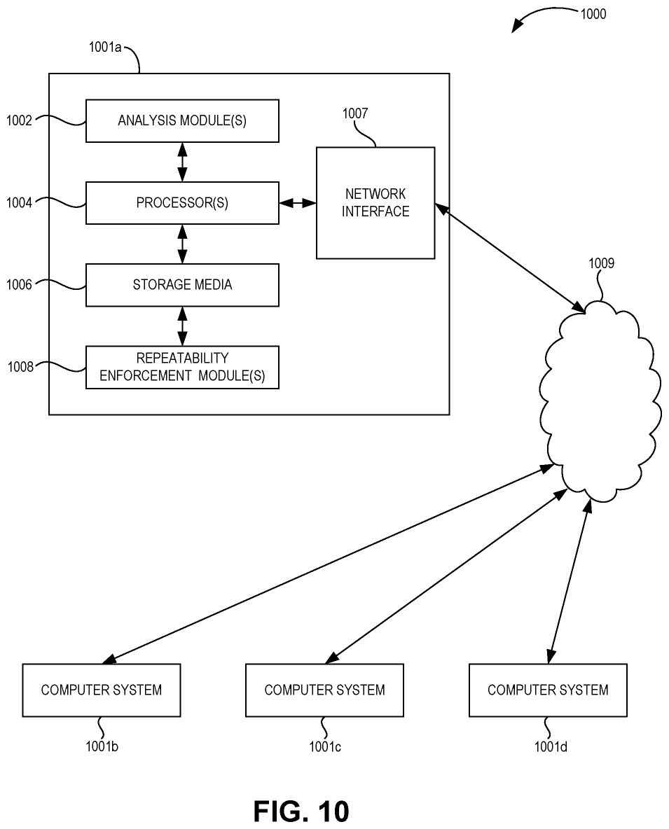

In some embodiments, any of the methods of the present disclosure may be executed using a system, such as a computing system. FIG. 10 illustrates an example of such a computing system 1000, in accordance with some embodiments. The computing system 1000 may include a computer or computer system 1001a, which may be an individual computer system 1001a or an arrangement of distributed computer systems. The computer system 1001a includes one or more analysis module(s) 1002 configured to perform various tasks according to some embodiments, such as one or more methods disclosed herein. To perform these various tasks, the analysis module 1002 executes independently, or in coordination with, one or more processors 1004, which is (or are) connected to one or more storage media 1006. The processor(s) 1004 is (or are) also connected to a network interface 10010 to allow the computer system 1001a to communicate over a data network 1009 with one or more additional computer systems and/or computing systems, such as 1001b, 1001c, and/or 1001d (note that computer systems 1001b, 1001c and/or 1001d may or may not share the same architecture as computer system 1001a, and may be located in different physical locations, e.g., computer systems 1001a and 1001b may be located in a processing facility, while in communication with one or more computer systems such as 1001c and/or 1001d that are located in one or more data centers, and/or located in varying countries on different continents).

A processor can include a microprocessor, microcontroller, processor module or subsystem, programmable integrated circuit, programmable gate array, or another control or computing device.

The storage media 1006 can be implemented as one or more computer-readable or machine-readable storage media. Note that while in the example embodiment of FIG. 10 storage media 1006 is depicted as within computer system 1001a, in some embodiments, storage media 1006 may be distributed within and/or across multiple internal and/or external enclosures of computing system 1001a and/or additional computing systems. Storage media 1006 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAYR disks, or other types of optical storage, or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In some embodiments, computing system 1000 contains one or more repeatability enforcement module(s) 1008. In the example of computing system 1000, computer system 1001a includes the repeatability enforcement module 1008. In some embodiments, a single repeatability enforcement module may be used to perform some or all aspects of one or more embodiments of the methods. In alternate embodiments, a plurality of repeatability enforcement modules may be used to perform some or all aspects of methods.

It should be appreciated that computing system 1000 is only one example of a computing system, and that computing system 1000 may have more or fewer components than shown, may combine additional components not depicted in the example embodiment of FIG. 10, and/or computing system 1000 may have a different configuration or arrangement of the components depicted in FIG. 10. The various components shown in FIG. 10 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of protection of the invention.

Geologic interpretations, models and/or other interpretation aids may be refined in an iterative fashion; this concept is applicable to embodiments of the present methods discussed herein. This can include use of feedback loops executed on an algorithmic basis, such as at a computing device (e.g., computing system 1000, FIG. 10), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. Moreover, the order in which the elements of the methods are illustrated and described may be re-arranged, and/or two or more elements may occur simultaneously. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method, comprising:
receiving baseline data representing an area corresponding to a first time;
receiving first measurement data representing a first portion of the area corresponding to a second time subsequent to the first time;
training a machine learning model to reduce an influence of a non-repeatability factor based on a combination of the baseline data and the first measurement data;
receiving second measurement data representing a second portion of the area corresponding to the second time, wherein the second portion of the area includes a feature of interest that was not present at the first time or that has changed between the first and second times; and
modifying the second measurement data using the machine learning model to remove the non-repeatability factor in the second measurement data.

2. The method of claim 1, further comprising generating or modifying the feature of interest after the first time and before the second time.

3. The method of claim 2, wherein generating or modifying the feature of interest is selected from the group consisting of injecting CO2 into a well and producing a fluid from a subsurface reservoir.

4. The method of claim 1, wherein the baseline data, the first measurement data, and second measurement data each comprises seismic data.

5. The method of claim 1, wherein the baseline data represents the first and second portions of the area at the first time.

6. The method of claim 1, further comprising preprocessing the baseline data and the first measurement data to permit a comparison therebetween.

7. The method of claim 1, wherein the non-repeatability factor comprises shallow depth perturbation that is not related to subsurface geologic characteristics.

8. The method of claim 1, further comprising at least one of visualizing an image of the area using the modified second measurement data or adjusting a physical parameter of a physical machine based at least in part on the modified second measurement data.

9. A computing system, comprising:
one or more processors; and
a memory storing instructions that, when executed by at least one of the one or more processors, cause the computing system to perform operations comprising:
receiving baseline data representing an area corresponding to a first time;
receiving first measurement data representing a first portion of the area corresponding to a second time subsequent to the first time;
training a machine learning model to reduce an influence of a non-repeatability factor based on a combination of the baseline data and the first measurement data;
receiving second measurement data representing a second portion of the area corresponding to the second time, wherein the second portion of the area includes a feature of interest that was not present at the first time or that has changed between the first and second times; and
modifying the second measurement data using the machine learning model to remove the non-repeatability factor in the second measurement data.

10. The computing system of claim 9, wherein the operations further comprise generating or modifying the feature of interest after the first time and before the second time.

11. The computing system of claim 10, wherein generating or modifying the feature of interest is selected from the group consisting of injecting CO2 into a well and producing a fluid from a subsurface reservoir.

12. The computing system of claim 9, wherein the baseline data, the first measurement data, and second measurement data each comprise seismic data.

13. The computing system of claim 9, wherein the baseline data represents the first and second portions of the area at the first time.

14. The computing system of claim 9, wherein the non-repeatability factor comprises shallow depth perturbation that is not related to subsurface geologic characteristics.

15. The computing system of claim 9, wherein the operations further comprise at least one of visualizing an image of the area using the modified second measurement data or adjusting a physical parameter of a physical machine based at least in part on the modified second measurement data.

16. A non-transitory, computer readable medium storing instructions that, when executed by at least one processor of a computing system, cause the computing system to perform operations, the operations comprising:
receiving baseline data representing an area corresponding to a first time;
receiving first measurement data representing a first portion of the area corresponding to a second time subsequent to the first time;
training a machine learning model to reduce an influence of a non-repeatability factor based on a combination of the baseline data and the first measurement data;
receiving second measurement data representing a second portion of the area corresponding to the second time, wherein the second portion of the area includes a feature of interest that was not present at the first time or that has changed between the first and second times; and
modifying the second measurement data using the machine learning model to remove the non-repeatability factor in the second measurement data.

17. The computer readable medium of claim 16, wherein the operations further comprise generating or modifying the feature of interest after the first time and before the second time.

18. The computer readable medium of claim 17, wherein generating or modifying the feature of interest is selected from the group consisting of injecting CO2 into a well and producing a fluid from a subsurface reservoir.

19. The computer readable medium of claim 16, wherein:
the baseline data, the first measurement data, and second measurement data each comprises seismic data; and
the baseline data represents the first and second portions of the area at the first time.

20. The computer readable medium of claim 16, wherein the non-repeatability factor comprises shallow depth perturbation that is not related to subsurface geologic characteristics.
